(19) United States
(12) Patent Application Publication
(10) Pub. No.: US 2006/0181062 A1
(43) Pub. Date: Aug. 17, 2006

(54) Convertible shopping - laundry cart with all purpose basket and - laundry accessories

(75) Inventor: Jean Ionie Robinson, Bronx, NY (US)

Correspondence Address: JEAN IONIE ROBINSON;APT # 3B, 3511 HULL AVENUE, BRONX, NY, 10467, US

(73) Assignee: Jean Ionie Robinson

(21) Appl. No.: 10/997,658

(22) Filed: Feb. 15, 2005

(51) Int. Cl. B62B 3/00

(52) U.S. Cl. 280/639

(57) ABSTRACT

It has multiple purposes: Shopping-Cart: Converts into laundry cart when laundry bag is placed in it Cart-Basket: To hold large grocery items like paper towel packages etc. Cart-Bottom: Metal-plate placed over metal wires to prevents small and perishable items. Removable Plastic Hangers with Hooks: Easy after wash care for—shirts, pants, skirts etc. Saves time, electricity, and money on ironing. Laundry Bag: Saves time. Stores dirty laundry, folded clothing place into laundry-cart at the same time Lingerie Bag: Holds fine clothing, small children's underwear, socks, and sneakers for wash. Drier Friendly—do not have to remove clothes from bag; prevents loss of small clothing. Sanitary Plastic Disposable Sheet Covering: Protects washed clothing from getting soiled, picking up germs from Laundromat baskets. Washable Sanitary Cloth Towel: Cleans Laundromat tables for clean clothes placement and hand purposes. Money Holders: Holds and allows easy and safe access to change for washing machines and dryers. Display: Accessories sold separately.

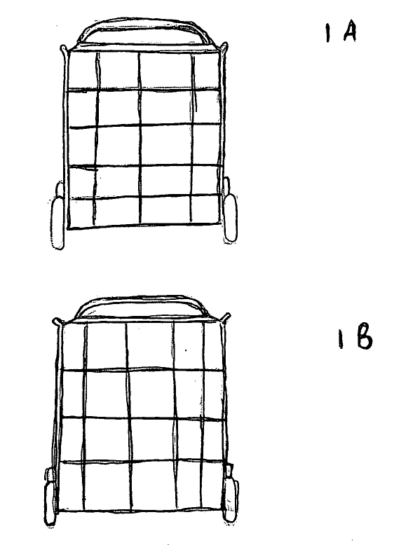

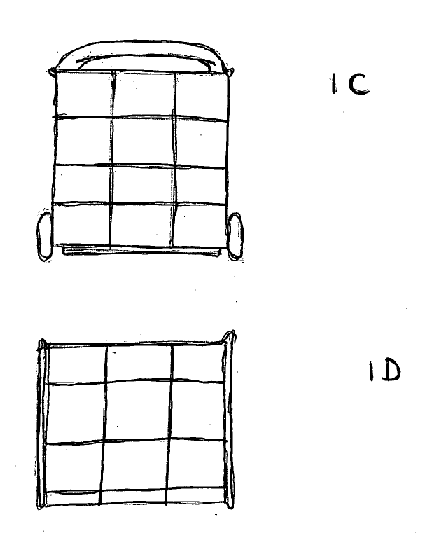

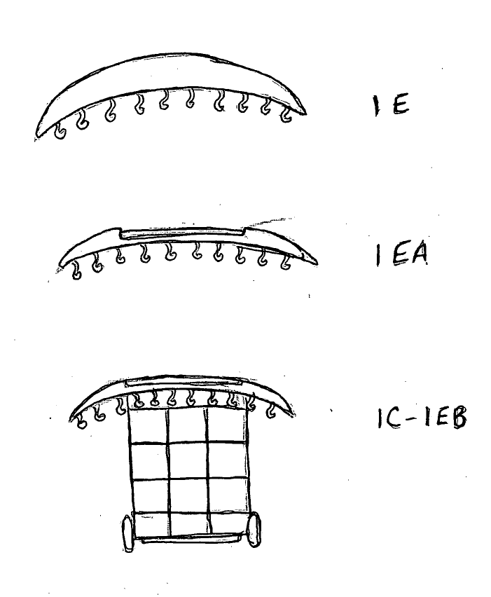

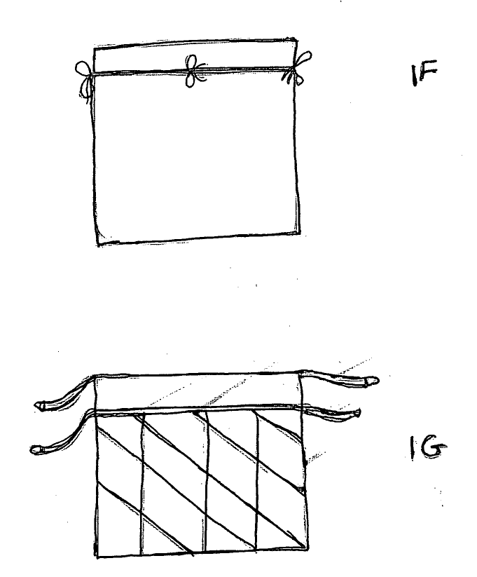

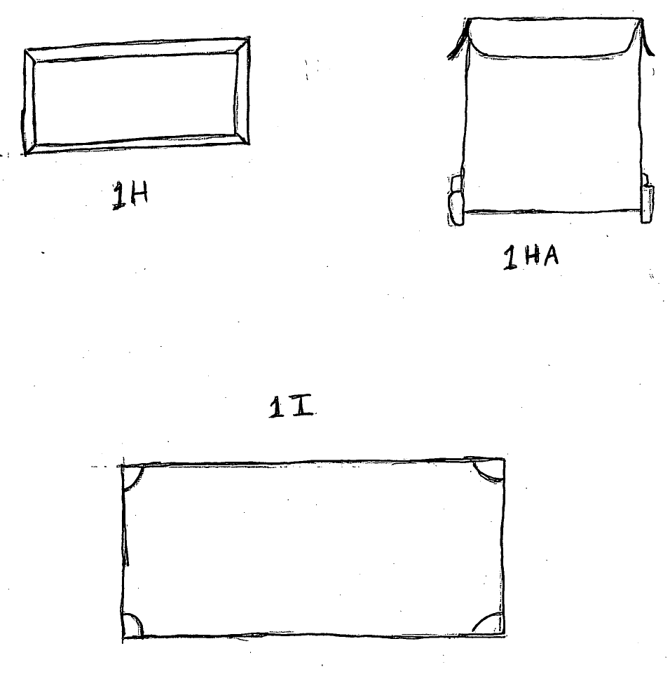

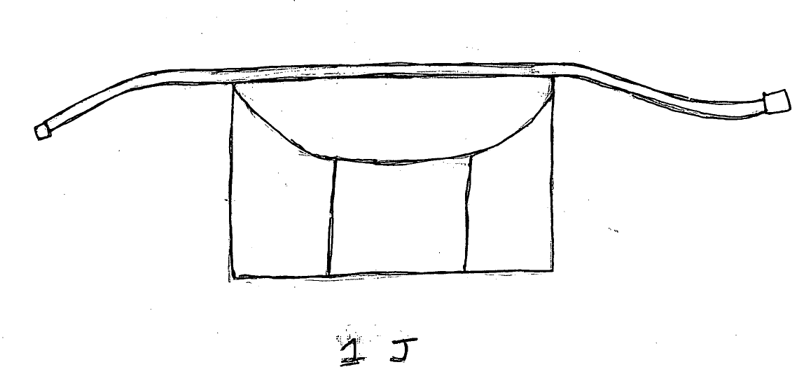

### SPECIFICATION: Drawing—1C

Back of Shopping Cart
Two large cartwheels
Metal handle with plastic or rubber covering for easy holding and pushing

Cart Bottom
Metal placed over metal wires to secure small items
Length: 24 inches
Width: 20 inches
Style: Square: Metal material
Cart-handle: Oval, half-moon shaped with plastic covering
Colors of Cart: Polished metal and painted beige
Colors of handle: Polished metal with clear heavy duty plastic covering and painted beige with beige heavy-duty plastic covering

### SPECIFICATION: DRAWING—1D

In front of shopping and laundry cart attached four inches below—from top edge of cart to accommodate laundry bag and metal-wire basket.

Basket to place in front of cart with mechanism at the sides of the basket to close-fold for easy carrying and storage purposes when not in use—like a standard cart
Style: Square
Colors: Polished metal and painted beige
Length: 14 inches
Width: 14 inches

### SPECIFICATION: DRAWING—1E

Removable plastic hanger with hooks placed over the back of the cart-handle.

Hanger with hooks made to fit, with space in the middle of the hanger for easy, comfortable hand placement and cart pushing.
Length: 20 Inches
Colors: Clear and beige heavy duty plastic

### SPECIFICATION: DRAWING—1F

Laundry bag made to fit snuggle into shopping and laundry cart—measuring from the bottom to the top—when placed into cart for laundry purposes.

Laundry bag—drawstrings at both sides with a four inch hem-fold bough-knot. It ties in the center—back and front of bag—to keep bag in place—when placing clothing in it.
Material: Heavy duty calico—non-shrinkable
Color: Beige
Length: 24 inches
Width: 20 inches

### SPECIFICATION: DRAWING—1G

Lingerie Laundry bag for machine wash and dryer purposes
Length: 19 inches
Width: 15 inches
Hem fold top lining—4 inches deep—calico with double stitches for double drawstring attachment at both sides of lingerie bag.
Material: Strong white nylon that can withstand heat (for drying purposes)
Style: Fishnet

### SPECIFICATION: DRAWING—1H

Sanitizer disposable plastic sheet covering for standard Laundromat basket.
Material: Medium thick clear plastic edges bound with black plastic stitches
Length: 60 inches
Width: 60 inches

With split at four corners, overlapping the bottom portion of the sheet. The plastic covering will hang over four inches on the Laundromat basket.

### SPECIFICATION: DRAWING—1I

Laundromat cloth for laundry table and towel hands
Material: Thick calico
Color: Beige
Style: Oblong, hemstitched 2 inch fold on each side, overlapping each hemstitch
Length: 12 inches
Width: 8 inches

### SPECIFICATION: DRAWING—1J

### Laundry Coin and Paper Money Holders

Laundry coin bag
Material: thick calico
Color: Beige
Style: Square
Length: 10 inches
Width: 10 inches

Coin bag holder's edge folds 3 times and stitches 3 times for easy access
Paper money holder (in front of the coin bag)
Length: 8 inches
Width: 8 inches
The flap's over-fold is 4 inches long with Velcro stitched on the flap and paper money holder
Waistband: Stretch Velcro material that attaches to sides of coin and money bag holders—to faster at the back of the body.

1. Jean Ionie Robinson, claims the invention of The Convertible Shopping and Laundry Cart Basket. Its intended use is for comfortable and easy practical shopping and laundry purposes.
How the invention came about: In the year 2002, I invented the Shopping and Laundry Cart with Basket and Accessories because of my constant frustrations with doing grocery shopping and laundry in conventional carts. I saw a need to improve the shopping cart.
Due to lack of knowledge and finances, I was prevented from submitting my invention until November 2004.
Recently, available are shopping and laundry carts with baskets, but they are too small for all purpose usage and the basket placement at the rear of the carts are uncomfortable when pushing the cart. For example, it is cumbersome when pushing because the body extends backwards instead of in a forward position with body alignment.
With my invention, the basket will be placed in the front of the cart for comfort when pushing. The basket will close independently of the cart—which allows the cart to open and close in 2 ways, almost like having 2 carts. The basket will keep close if not needed and for storage. The baskets and carts available close only one way.
My basket will be able to hold bulky grocery items like paper towels, toilet paper packages and beverages. Also, my cart will be more useful for laundry purposes: to hold wet clothing in protected bags along with laundry accessories and detergents.
The Convertible Shopping and Laundry Cart with All Purpose and Laundry Accessories will better serve practical usages in more than one way.
